(19) United States
(12) Patent Application Publication
(10) Pub. No.: US 2009/0139511 A1
(43) Pub. Date: Jun. 4, 2009

(54) Charcoal restraints

(76) Inventor: Albert Ernest Dalrymple, San Jose, CA (US)

Correspondence Address: Albert Ernest Dalrymple, 120 Tiffin Dr., San Jose, CA, 95136, US

(21) Appl. No.: 11/998,953

(22) Filed: Dec. 3, 2007

(51) Int. Cl. A47J 37/07

(52) U.S. Cl. 126/25 R

(57) ABSTRACT

Charcoal Restraints is a device which converts a conventional barbeque grill into a indirect cooker by modifying the grill's heat relocate characteristics. The device blocks the main beaming heat relocate pathway, extends the conductive heat relocate pathways and allows convection heating as the primary means of cooking. The device divides the fuel, provides adequate air stream to maintain burning.

### BACKGROUND OF INVENTION

The barbeque experts who have been using barbeque grills for a long time, generally agree that the most flavorful and tender barbequed meats are cooked slowly with the indirect heat cooking method. Barbeque cooking falls into two categories, grills and smokers. Comparing the two; Grills are designed to cook meats at high temperature resulting in over cooked, dried, and in some cases black burned foods. Smokers are designed to slowly cook meats at much lower temperatures by means of using the smoke to lower the heat input and extending the cooking time of the food.

Grill manufactures state that using the indirect heat cooking method can be used in their grill designs to slowly cook and smoke meats. However in doing so it is very difficult due to the heat relocation characteristics of their grill design and current grilling accessories on the market today. A typical barbeque grill utilizes three forms of heat transfer to cook food: a) Emission, b) Conductance, and c) Convection. Heat energy is transferred from a hot body to a cold body by this combination. A typical barbeque smoker is designed to utilize convection heat transfer as its primary means of cooking.

### FIELD OF INVENTION

This invention is a charcoal restraints system that is used in the indirect heat cooking method. The charcoal restraint system can be used with standard barbequed grills on the market today.

### PRIOR ART

The current method of indirect heating for a barbeque grill is to divide the charcoal into areas away from the central charcoal grate center. Then a drip pan is placed in the center of the charcoal grate that is free of any charcoals. Heat is transferred by emission from a hot body in a straight line in every direction. In the case of the conventional indirect heating method, beaming heat energy is transferred to the cooking food as shown in FIG. 1. Convection heat energy is also transferred to the food by air heated while passing through the burning charcoal and circulated around food. Finally, the cooking grate is heated by both emission and convection energy. The metal cooking grate conducts the heat to the cooking food by means of conduction.

### SUMMARY OF INVENTION

Charcoal Restraints; see FIG. 2, is a device that converts a barbeque grill into an efficient indirect cooker. The charcoal restraints as shown in FIG. 3 creates a fence that restrain the charcoal from the direct broadcast path of the beaming energy preventing it form reaching the cooking food. Heat rises, reflects off the grill lid and inside surfaces of the grill, and slowly cooks the food evenly on all sides. The circulating heat works much like a convection oven, so there is no need to turn the food. Conductive heat transfer through the cooking grate is also greatly reduced; because, of the reduced surface area available to absorb heat energy and the longer broadcast path to the cooking food.

### BRIEF DESCRIPTION OF THE DRAWING

The charcoal restraints are shown in the drawing as being formed from a single wire. In a certain way to fit the required charcoal grates on the market today.

FIG. 1 is a side view of conventional indirect barbeque cooking method.

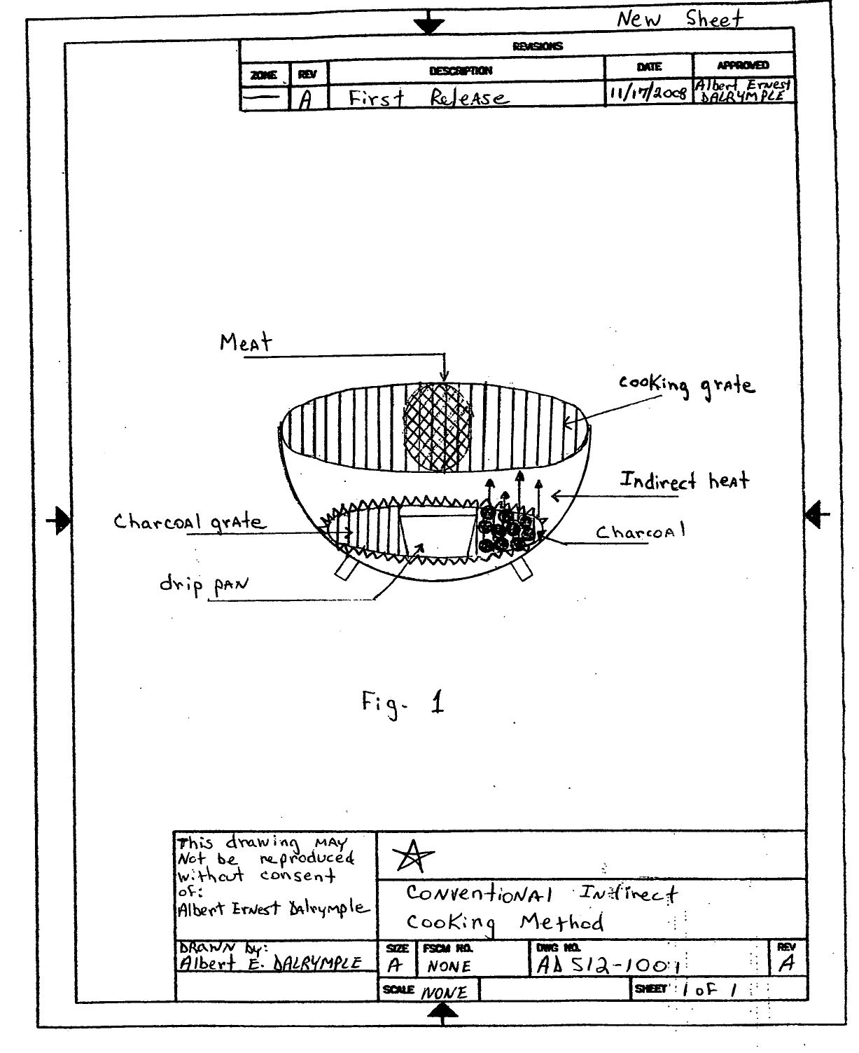

FIG. 2 is a front and side view of charcoal restraints.

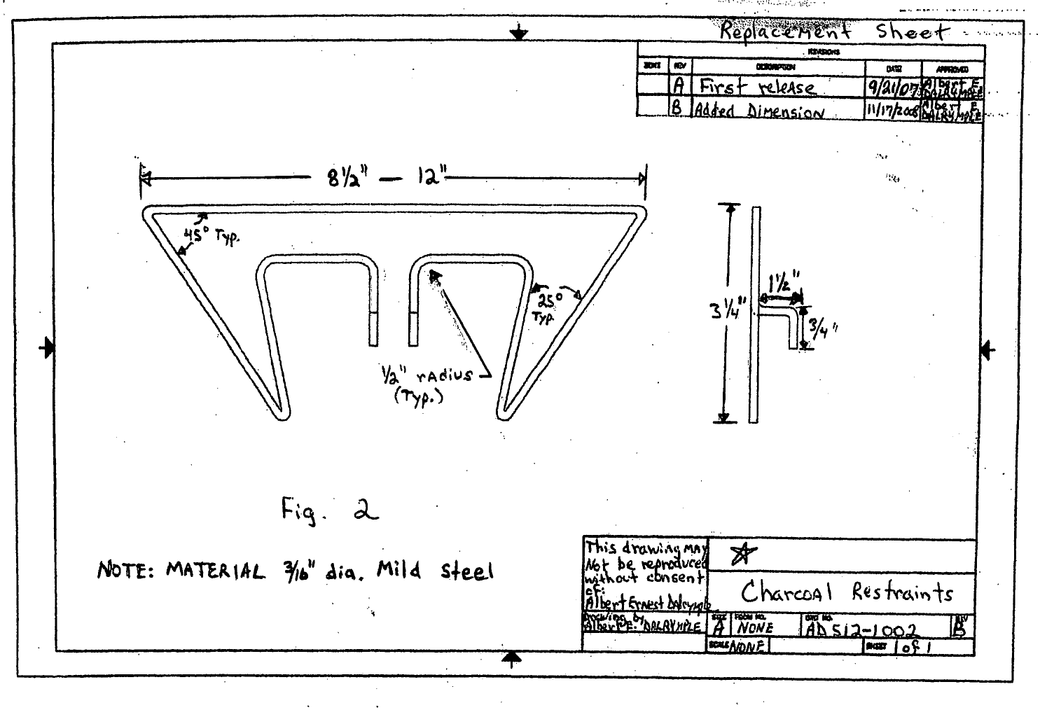

FIG. 3 is a side view of charcoal restraints cooking method.

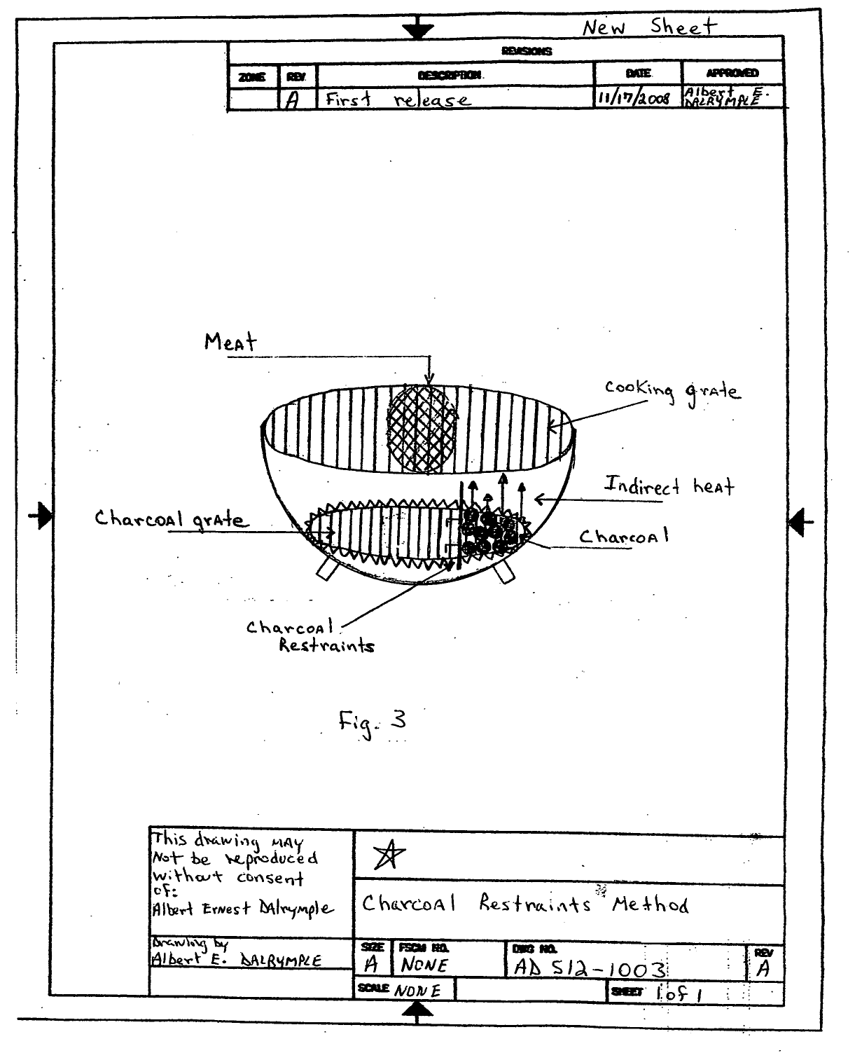

FIG. 4 side view of charcoal restraints typical configuration.

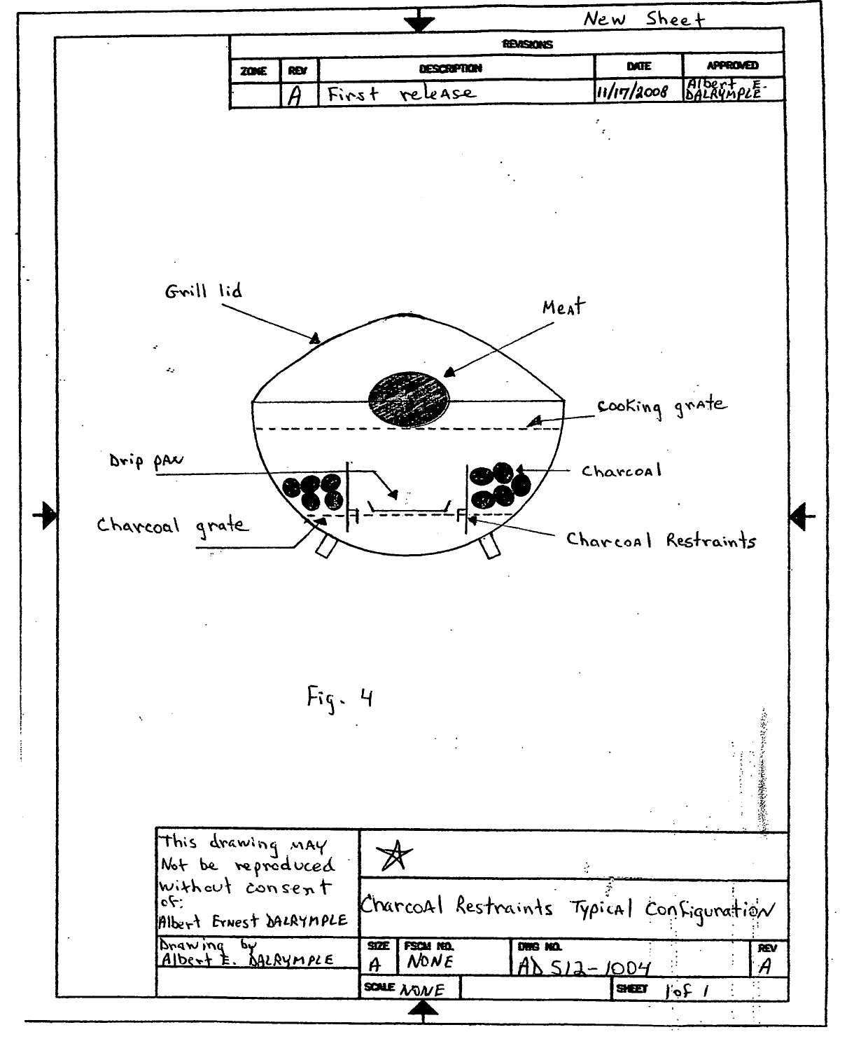

### DETAIL DESCRIPTION OF THE DRAWING

The charcoal restraints which are formed from a single wire are designed to hook onto the charcoal grate. Creating a fence that restrain the charcoal in place and away from the center of charcoal grate. Thus providing the indirect heat cooking method that is so desired.

### DRAWING

Please see attached drawing.

1. I claim a device for placing in a barbeque grill which modify the heat relocate characteristics converting the grill into a indirect cooker by: a) creating a fence to reduce the beaming heat transfer, and b) reducing conductive heat reassign by extending the broadcast pathways, while c) permitting convection heating of the cooking food.

2. I claim a barbeque grill design which contains a device which alters the heat relocate characteristics converting the grill to an indirect cooker by: a) creating a fence to reduce the beaming heat transfer, and b) reducing conductive heat relocate by extending the broadcast pathways, while c) permitting convection heating of the cooking food.
